(19) United States
(12) Patent Application Publication
(10) Pub. No.: US 2004/0146183 A1
(43) Pub. Date: Jul. 29, 2004

(54) Method and system for tracking an object

(76) Inventor: Yair Shimoni, Mevasseret Zion (IL)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,144

(22) PCT Filed: Jan. 23, 2002
(86) PCT No.: PCT/IL02/00066

(30) Foreign Application Priority Data
Feb. 26, 2001 (IL) 141650

(51) Int. Cl. G06K 9/00; G06K 9/62

(52) U.S. Cl. 382/103; 382/209

(57) ABSTRACT

The invention provides a method for tracking characteristics of an object, the method including acquiring image data of a first image of the object to be tracked, as viewed by an imaging unit; storing data representing a selected portion of the first image, thus forming a first template having first defined dimensions; storing data representing at least one different portion of the first image, thus forming a second template having second template dimensions; acquiring image data of a second image of the object to be tracked, as viewed by the imaging unit; defining a search area comprising portions of the second image; defining a first gate in the search area, the gate possessing dimensions identical to those of the first template, thus forming a first template/gate pair; defining at least one second gate in the search area, the at least one second gate possessing dimensions identical to those of the second template, thus forming at least one second template/gate pair; the template/gate pairs being stored in the form of pixel values; calculating correlations between the data of the template/gate pairs at different locations in the search area; determining the locations of each template/gate pair where the correlations are the highest, and noting the determined locations. The invention further provides a system for tracking characteristics of an object.

### FIELD OF THE INVENTION

The present invention relates to a method and a system for following the characteristics of an object, and more particularly, to a method and a system for tracking an object by using correlation in multiple template/gate pairs.

The image of an object has a large number of characteristics, such as its size, orientation, internal structure and the like. In many applications, it is necessary or advantageous to follow some of these characteristics through a series of images taken at a series of time points. A notable application of this kind is object tracking. The present invention proposes a method and a system which allow following the characteristics of the object even when it changes its orientation, changes its distance from the imaging system, or becomes partially obscured.

### BACKGROUND OF THE INVENTION

As illustrated in FIG. 1, an image consists of a matrix of pixels PX, arranged in a rectangular matrix E. Each pixel has a value associated with it, representing the intensity of a flux C. The flux usually (but not always) consists of photons or phonons impinging on imaging means, such as detector and digitizer D, from a given direction. The arrangement of the pixels in the pixel matrix E is such, that when display screen G is activated by a display processor F, its elements are arranged in the same order as the pixels and the brightness in each element is a monotonic function of the pixel value; the human eye perceives an image H of the scene A having an object B imaged by imaging means D. If the detector has only one spectral band, then the pixel values are also referred to as “gray levels.” It is usual in such cases to display the image in tones of gray.

FIG. 2 illustrates a pixel matrix E, displaying an image of the scene A of FIG. 1 by pixels in three gray levels.

The term “image,” as used herein, refers indiscriminately to the matrix of stored pixel values or to the displayed image on the screen.

The term “scene,” as used herein, refers to the portion of the outside world that is being imaged, or to a selected part of that portion.

An object B in the scene (FIG. 1) is visible in the matrix E if the pixels I₂ (FIG. 2) associated with the direction of flux from the object to the imaging means have values which are different from the surrounding pixels I₁, which represent the background behind the object in the scene. The pixels representing the object then form a blob or several blobs J, having a common property that is different from that of the other pixels. This property is usually (but again, not always) the gray level/pixel value/flux intensity. It is the blob J whose properties and characteristics are measured.

A large number of characteristics can be derived from the blob, such as the center of gravity, geometric center, size (or area), length, circumference, the ratio between the area and the circumference, other ratios, the number of corners, the histogram of pixel values and the spatial distribution of pixel values. By way of example only and not as a limiting constraint, the description herein will refer mainly to pixel value spatial distributions over the entire blob and pixel value spatial distributions over selected parts of the blob.

One method of matching a characteristic of an object, such as its pixel value spatial distribution in one image, to the same characteristic of the same object in another image, is by using correlation. The mathematical term “Linear Correlation” refers to a statistical method which is not sensitive to linear variations of the gray levels of the image. However, linear correlation is sensitive to changes of shape, which may be caused by a change in the distance between the object and the imaging device, by changes in the relative orientation between the object and the imaging device, or by obscuration of the object. Such obscuration may be partial, parts of the objects still being visible, or complete.

The linear correlation r(x,y) between the two variables x and y is defined as:

r(x,y)=cov(x,y)/\sqrt{var(x)*var(y)} [1]

where the positive sign of the square root is taken. Var(u) is the variance of the variable u (x or y), which may be defined as:

$$var ( u ) = ( {\sum }_{k = 1}^{N} {( {u}_{k} - \overline{u} )}^{2} ) / N \qquad [ 2 ]$$

Here and below, k is an index ranging over all elements in the selected group. Both variables must have the same number of elements. The mean of the pixel values uₖ is defined as:

$$\overline{u} = ( {\sum }_{k = 1}^{N} {u}_{k} ) / N \qquad [ 3 ]$$

and the covariance of the two variables may be defined as:

$$cov ( x , y ) = ( {\sum }_{k = 1}^{N} \{ ( {x}_{k} - \overline{x} ) ( {y}_{k} - \overline{y} ) \} ) / N \qquad [ 4 ]$$

The values of linear correlation value range from −1 to +1, where +1 denotes exact similarity, −1 denotes exact color reversal and 0 denotes no relationship between the two variables.

Other correlation methods may also be used, but it is generally accepted that under most conditions, linear correlation yields results which are the most indicative of shape changes, and whose values can be compared quantitatively and not only qualitatively. The reason why other types of correlation are used is that linear correlation requires heavy computations. Sensitivity to shape change is common to all correlation methods, as all of these methods are based on the spatial distribution of the pixel values.

As a non-limiting example, the case of a tracking means, or tracker, is used herein. In general, there are two categories of trackers: the first is scene trackers, which help in detecting objects hidden in the scene, either by keeping the scene relatively stationary in the image or by constantly pointing to the selected portion of the scene. Detection is then done either by an experienced observer watching the display screen or by use of another computer program, such as a motion detector. Detection is often followed by the transfer of control to an object tracker. The second kind of tracker is an object tracker, which follows a given object of interest. The object of interest may be either stationary or moving relative to the background scene.

The main purpose of a tracker or tracking means is reporting the location of a selected object, or a scene, in the image. Many trackers have, in addition, means for changing the direction towards which the imaging means is pointed (termed “line of sight”) in response to said reporting, so as to keep the tracked object as close to stationary within the image as possible. Usually, it is attempted to keep the object stationary at the middle of the image. Sometimes the term “tracker” refers to the combined system (including both the reporting and directing means).

Trackers usually use a feature characteristic of an object in order to determine its location. This characteristic may be the center of gravity (the average position calculated by weighting the position of each pixel by a function of its pixel value), a position based on one or more of the object's edges, etc. However, it is usually accepted that, for objects which subtend a large enough number of pixels, the best results are obtained using correlation methods which utilize all of the pixels in the scene or in the object's blob, and their values.

Correlation is based on comparing the scene or blob in the current image to a reference scene or blob, usually taken from a previous image or from an average of several previous images. It is usual to limit the size of the reference; for a reference blob not much else is included and for a reference scene, only so much of the scene is included as is allowed by the computing power of the system. It is also usual, but not necessary, to include the edges of the blob in the comparison, thus enabling comparison of the external shape. Reference scenes for scene trackers do not have such edges.

Selection of the reference, called the template, is a major factor in the success of the tracking. It is customary to store only this template, as the rest of the reference image has no use.

For the sake of convience of calculation, rectangular templates may be used whose sides are parallel to the lines and columns of the image matrix. Under these conditions, Equations [2]-[4] may be rewritten as:

$$var ( u ) = ( {\sum }_{i = 1}^{n} {\sum }_{j = 1}^{m} {( {u}_{i , j} - \overline{u} )}^{2} ) / ( n * m ) \qquad [ 5 ]$$

where the mean is:

$$\begin{matrix}\overline{u} = ( {\sum }_{i = 1}^{n} {\sum }_{j = 1}^{m} {u}_{i , j} ) / ( n * m ) \\ and & [ 6 ] \\ cov ( x , y ) = ( {\sum }_{i = 1}^{n} {\sum }_{j = 1}^{m} ( {x}_{i , j} - \overline{x} ) * ( {y}_{i , j} - \overline{y} ) ) / ( n * m ) & [ 7 ]\end{matrix}$$

where the means for x and y are as defined in equation [6].

In equations [5]-[7], the variables x and y stand for the reference and the current images, while i and j stand for line and column counters, starting at 0 from the origin of the template and from any selected point in the current image. The counter i ranges from 1 to n and the counter j ranges from 1 to m in this representation. It is obvious that the dimensions of the rectangular scene in the current image must match exactly to those of the template. The requirement for equality of dimensions is true also for approximate correlations.

Correlative trackers, searching for the location of a blob in the image, compute the correlation between the template and the image at many different locations. At each of these locations, a “window” or “gate” is opened on the image, having exactly the same dimensions as the template. The correlation with the template is calculated and the position of the maximal correlation is established, sometimes with sub-pixel accuracy. This position is then taken as the object's position in the current image, and other characteristics of the object may then be derived. From the definition of the linear correlation it is clear that if the reference image is taken as the current image, the correlation equals unity and is maximal when the position of the gate is at the position from which the template was taken.

The superiority of the results of correlative methods over those of other methods is true only as long as the object does not change its shape. That is, as long as the object's current blob is similar to the stored one, namely, the blob of the template. In most cases, however, due either to the object's motion, motion of the imaging means or motions of obscuring elements, the object's apparent shape does change and with it, its associated blob in the image also changes.

For the purpose of uninterrupted tracking, template updating takes place from time to time. Selecting the moment for updating is another major factor in tracking success. Some systems do updating after every image and others at given intervals, while still others may use a tracking quality factor to determine the need for template updating.

Correlation has an intrinsic advantage over most other characteristic following methods, in that it has a built-in quality factor: the correlation value. A more complex quality factor may be obtained by also using the temporal behavior of the correlation and by using additional data, such as the temporal behavior of the object's location, as reported by the tracking means. This quality measurement may indicate that the blob being currently characterized is so dissimilar to the template that some action is needed.

However, the required action is not always the same. If a reduction in quality results, for example, from a change of presentation of the object following its turning, or from a change in size of the blob due to a change in the object's distance from the imaging means, then a template update is in order. If the reduction in quality results from an obscuration of the object that is caused by a different object passing through the line of sight between the object and the imaging means, the template updating may result in target switching, whereupon the system will henceforth follow the obscuring object even when the original object is no longer obscured.

It is evident that a different strategy is needed for the different cases, but the selection of the appropriate strategy depends on the ability to distinguish between them. In the case of obscuration, there are again strategies to choose from. One strategy is to switch to scene tracking and stop the line of sight at the last known position, assuming that the object will soon emerge from obscuration and be visible, whereupon it will be possible to track it again. Another strategy is to assume that the object continues to move behind the obscuration with the same motion parameters it had before it was obscured, and thus, to follow a theoretical, calculated, point in the hope that when the object emerges from obscuration it will be visible near that calculated point.

In both of the above strategies, as well as in others not described here, the probability of detecting the obscured object at the expected point diminishes with time. After a certain time, during which the correlation is so low that the object is deemed invisible, the tracking is considered to be lost, and a new search for the object is instigated. Extending the time during which the object is still visible and advancing the time of its rediscovery, shorten the obscuration time and increase the chances of success.

Computing the correlation consumes time. Correlative trackers, searching for the location of a blob in the image, compute the correlation between the template and a window or gate in the current image at many different locations, making the calculation unacceptably long. Scene trackers use templates large enough to include a substantial portion of the imaged scene.

Scene trackers sometimes use several sub-windows as a means for reducing computation. This procedure is based on the assumption that the changes in the positions of the blobs of stationary objects in the scene obey a simple law, which can be derived from a relatively low number of sub-scenes. The methods may assume constant motion, a bi-linear law, or any other law whose number of parameters is not greater than the number of sub-scenes used. However, the scene is assumed to be stationary and all motions in the image are the result of the motion of the imaging means.

It is the same large number of pixels which makes the calculation of the correlation lengthy in the first place, which also makes possible the division of the scene into sub-scenes.

Many object trackers turn to different solutions. Instead of using linear correlation, different approximations are used, such as Minimum Absolute Difference (MAD), which, while reducing computation time, exact a price on accuracy and consistency. The position to which they point may not be the best position. The method described herein applies also to these approximations.

Another common method of reducing the computation load is to prepare the template's values only once, during or immediately following acquisition of the template, and calculating for each current image only the values involving the pixel values of the current image. An example of this method is the calculation of template variance and mean, which does not involve the pixel values of any other image. A more advanced method is to replace the original template pixel values with the following modified pixel values

y′_{i,j}=y_{i,j}−\overline{y} [8]

which can be used in the equations both for var(y) and for cov(x,y). It is evident from equation [6] that the mean of y′ vanishes, simplifying the variance, but the main effect is on the covariance, which becomes

$$cov ( x , y ) = ( {\sum }_{i = 1}^{n} {\sum }_{j = 1}^{m} {x}_{i , j} * {y}_{i , j}^{′} ) / ( n * m ) . \qquad [ 9 ]$$

### DISCLOSURE OF THE INVENTION

It is the aim of the present invention to overcome many of the problems of traditional trackers and similar devices. The invention provides a fast method and system for calculating the correlation in several templates simultaneously. The method of the invention (a) improves the accuracy of locating the object; (b) indicates the reason for possible reductions in quality by distinguishing obscurations from motion-induced shape changes, thereby enabling correct template updating decisions, and (c) makes tracking during partial obscuration possible, thereby reducing and sometimes completely eliminating the total obscuration time, therefore increasing the probability of rediscovery.

Thus, the present invention provides a method for tracking characteristics of an object, said method comprising acquiring image data of a first image of the object to be tracked, as viewed by an imaging unit; storing data representing a selected portion of said first image, thus forming a first template having first defined dimensions; storing data representing at least one different portion of said first image, thus forming a second template having second template dimensions; acquiring image data of a second image of said object to be tracked, as viewed by said imaging unit; defining a search area comprising portions of said second image; defining a first gate in said search area, said gate possessing dimensions identical to those of said first template, thus forming a first template/gate pair; defining at least one second gate in said search area, said at least one second gate possessing dimensions identical to those of said second template, thus forming at least one second template/gate pair; said template/gate pairs being stored in the form of pixel values; calculating correlations between the data of said template/gate pairs at different locations in said search area; determining the locations of each template/gate pair where said correlations are the highest, and noting said determined locations.

The invention further provides a system for tracking characteristics of an object, said system being connectable to an imaging unit, comprising means for acquiring template data; a first memory for storing data representing at least two templates; means for acquiring image data; a second memory for storing at least two gate data selected from an area of the image to be searched; means for selecting gate positions in the search area; a third memory for storing template locations; a fourth memory for storing gate locations; a correlator receiving data from said first and second memories for comparing template data stored in said first memory to the gate data stored in said second memory and storing correlation values of template/gate pairs in a map memory; a maximum data memory storing a maximal correlation value for each template/gate pair, constantly replacing any previous correlation value which is lower than said maximal correlation value; means for calculating a shift vector between a template location and a gate location, and a central controller and processing unit.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

In the drawings:

FIG. 1 illustrates data flow from scene to image;

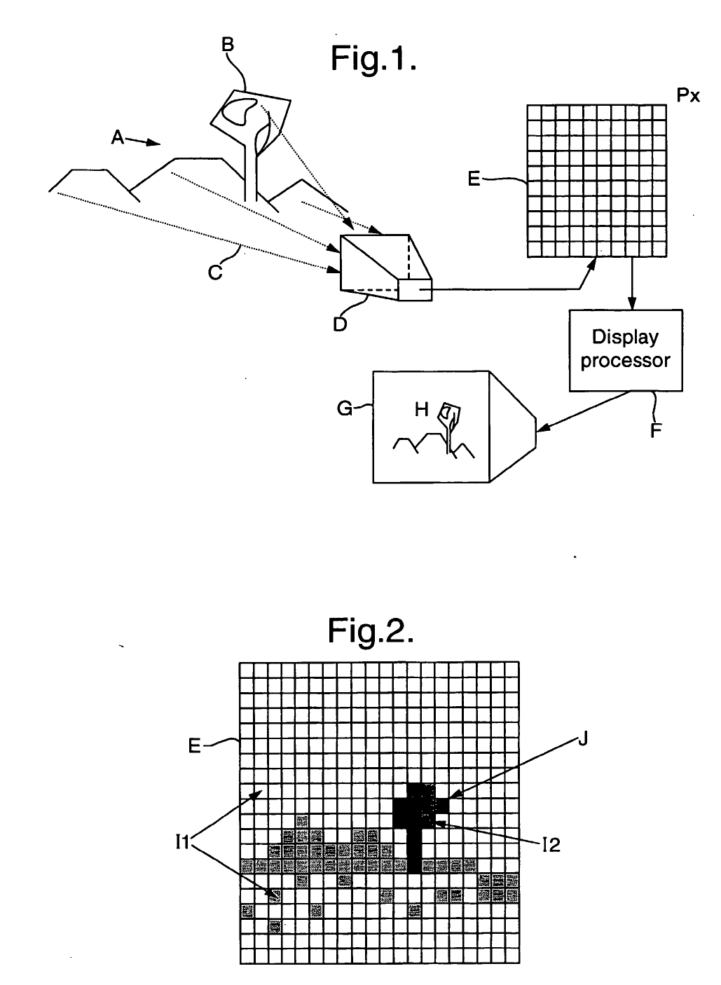

FIG. 2 illustrates a pixel matrix, showing the pixels of an image of a scene with three gray levels;

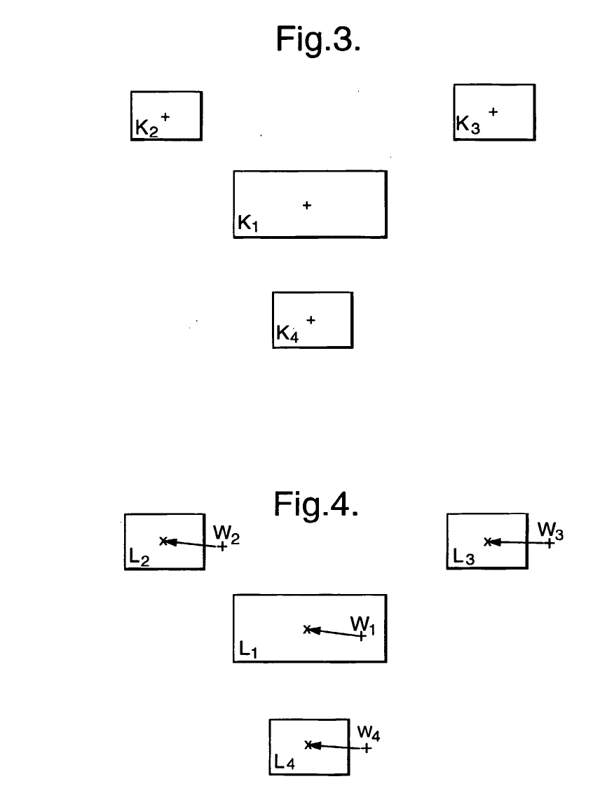

FIG. 3 schematically illustrates a possible arrangement of four templates;

FIGS. 4 to 8 schematically illustrate “best” gate positions and shift vectors for different motions relative to the line of sight of the templates of FIG. 3;

FIGS. 9 to 12 schematically illustrate possible different arrangements of four templates for object tracking;

FIG. 13 is a block diagram of a system for selecting templates and pre-processing them in accordance with the present invention;

FIG. 14 is a block diagram of a system for searching for the maximal correlation between templates;

FIG. 15 is a block diagram illustrating a first embodiment of the use of data from a plurality of template/gate pairs, and

FIG. 16 is a block diagram illustrating another embodiment of the use of data from a plurality of template/gate pairs.

### DETAILED DESCRIPTION

The invention provides a method for tracking the characteristics of an object through a series of images.

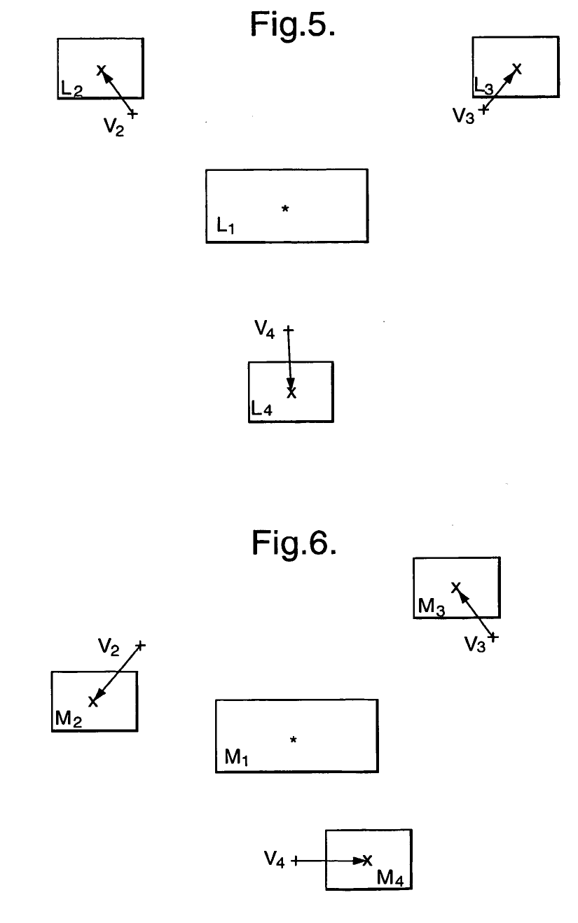

In an embodiment of the invention, a number of templates are utilized for an object tracker. FIG. 3 shows a possible arrangement of four templates K₁, K₂, K₃ and K₄. The number of templates and their relative positions are fixed for a given task. It should be noted that the arrangement of templates in FIGS. 3-8 is not a preferred arrangement, but rather, it is a possible arrangement which makes it easier to explain the proposed method graphically. One of the templates, hereinafter called the “main template” (marked K, in FIG. 3), is similar to the template that would be used by a single-template method. It contains the object's full blob but not much more. The other templates may be either larger or smaller than main template K₁. For the sake of convenience of calculation, rectangular templates may be used, whose sides are parallel to the lines and columns of the image matrix. This rectangular shape is not a limitation on the invention, but rather is used for convenience.

At each position in the current image where correlation is to be calculated, a matching set of gates is used, each gate matching the respective image, in shape, dimensions and position relative to the main gate. Correlations are calculated between each template and its respective gate, hereinafter referred to as “template/gate pair.” As this seems to increase the amount of calculations, the method also suggests arrangements of relative template positions that reduce the amount of calculations.

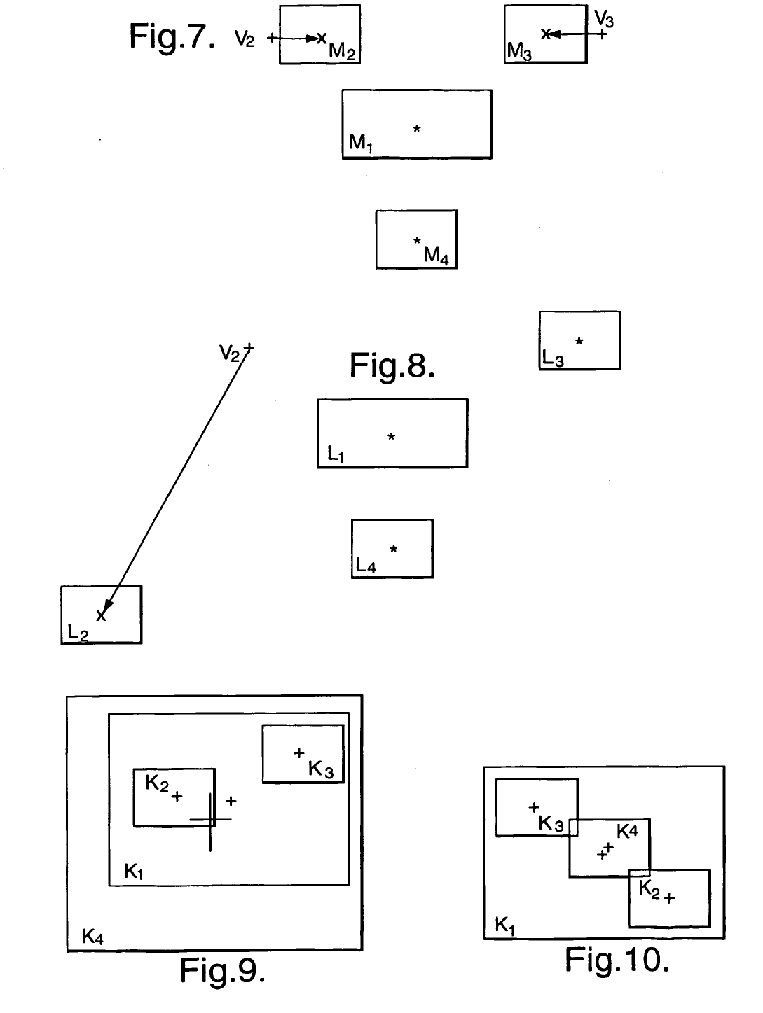

The search for the best location, where correlation is highest, is performed using the correlation in the main template and gate, and optionally also using the correlations in several other pairs. FIGS. 4-8 show gates L₁ to L₄ and their best positions for different motions relative to the line of sight between the tracked object and the imaging means, during the period between acquisition of the reference image and acquisition of the current image, referred to herein as the “interval period.”

The term “best position,” as used herein, refers to the position where the respective correlation is maximal.

The shift between the position of the main gate L₁ and the position of the main template K₁, shown in FIG. 4 as vector W₁, teaches about the motion of the tracked object transverse to the line of sight. The shifts between the positions of the other gates L₂ to L₄ relative to the main gate L₁ and the positions of the respective other templates K₂ to K₄ relative to the main template K₁, shown, for example, as vectors V₂ to V₄ in FIG. 5, teach about changes in the shape of the tracked object, and about the causes for these changes. The correlations in the different template/gate pairs can also be used to confirm or refute the conclusions derived from the relative shifts in position. As can be understood, straight crosses show the original positions of the templates K₁ to K₄, and tilted crosses show the positions of the current gates L₁ to L₄.

The relative shift vectors V₂-V₄ can be easily calculated from the shift vectors W₁-W₄, using the equation:

Vi=Wi−W1 [10]

where the index i ranges from 2 upwards, according to the number of additional templates used (two to four, in the case illustrated in FIG. 5, for example).

The same equation teaches that V₁ always vanishes, and that is why, in FIGS. 5-8, the main gate L₁ is shown at the position of the main template K₁.

FIG. 4 further illustrates a case where the tracked object moves only in a direction transverse to the line of sight during the interval period . The vectors W₁ to W₄ are very similar, making V₂ to V₄ (not shown) very small, showing relatively little change in the object's shape. In this case, the correlations in all the template/gate pairs are expected to be high, above a predetermined level.

In FIG. 5, there is illustrated a further case where the tracked object approaches the imaging means during the interval period. All the relative shift vectors V₂ to V₄ point essentially away from the center of the object. This is typical of an approaching motion. In a case where the tracked object recedes from the imaging means, the relative shifts point essentially towards the object's center. In both such cases, the correlation in the main gate L₁ should drop more than the correlations in the additional gates.

FIG. 6 illustrates a case where the tracked object rotates around the line of sight. All the relative shift vectors V₂ to V₄ are essentially perpendicular to the lines connecting the centers M₂ to M₄ of their respective gates to the center M₁ of the main gate. In such a case, the correlations in all the templates are reduced, as the shape of each part of the object changes with rotation.

FIG. 7 illustrates a case where the tracked object rotates around the vertical axis. All the relative shift vectors V₂ to V₄ point essentially horizontally toward the line which is vertical in the image and passes through the center of the object. The size of the relative shift vector increases with increasing distance of the gate from said line. This is why V₄ essentially vanishes and is not shown. In this case, the correlation in the main gate should drop more than the correlations in the additional gates.

FIG. 8 illustrates a case where the tracked object is partially obscured while moving transverse to the line of sight. In this illustration, the area of the image which is in the relative position of template K₂, which formerly showed part of the tracked image, now shows the obscuration. Gate L₂ no longer includes any data belonging to the tracked object; its best position shows part of the image which is more similar to the template than any other part, but is not necessarily even part of the tracked object. The relative shift vector V₂ is therefore not in agreement with the other relative shift vectors V₁, V₃, V₄ for any model of object motion. It is typical of partial obscuration that some relative shift vectors do not agree with others. In these cases, it is usual for the correlation in the obscured gates to be much lower than it is in a non-obscured case, and usually much lower than in the other gates. This enables distinguishing between obscured and non-obscured gates.

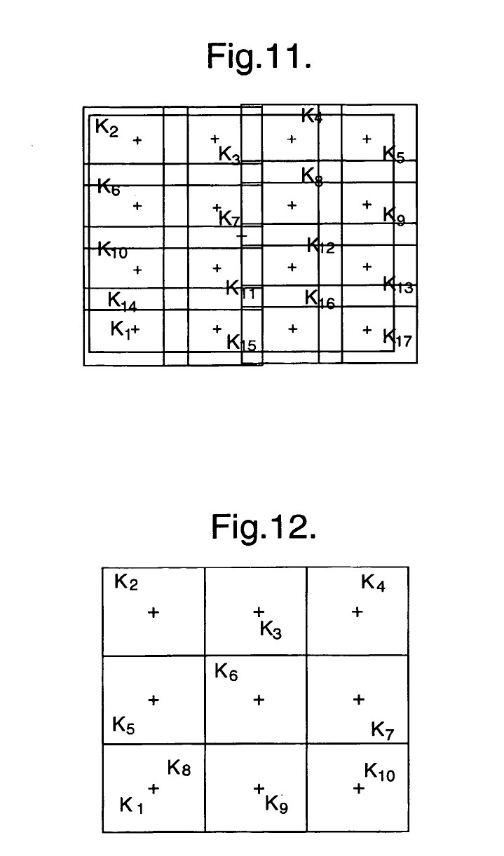

In a further embodiment of the invention, the method is applied to object tracking, where the main template includes essentially the entire blob of the tracked object. In this embodiment, shown in FIG. 9, the additional templates K₂, K₃, if smaller than the main template, are essentially inside the main template so that they include portions of the blob of the tracked object. Also, in this embodiment, an additional template K₄, if larger than the main template K₁, essentially contains within it the main template K₁, so that it also essentially includes the entire blob of the tracked object. Additional templates contained within the main template enable the simultaneous calculation of correlations in the main template/gate pair and in the pairs of said additional templates and their respective gates, with essentially no additional computation time.

In FIG. 10, there is illustrated a case where the main template K₁ includes essentially the entire blob of the tracked object. In this embodiment, additional templates K₂ to K₄ are used , whose dimensions are integer divisors of the main template, and which are essentially contained inside the main template, The divisor is 3, both for the column dimension and for the line dimension. Such templates enable the re-use of data for fast calculation of all relevant correlations over all of the search area. Simultaneous calculation is made possible by reducing the equations [5]-[7] to equations using the variables

$$\begin{matrix}D1 ( x , {i}_{0} , {j}_{0} , p ) = {\sum }_{i = {i}_{0} + 1}^{{i}_{0} + p} xi , {j}_{0} & [ 11 ] \\ D2 ( x , {i}_{0} , {j}_{0} , p ) = {\sum }_{i = {i}_{0} + 1}^{{i}_{0} + p} xi , {j}_{0}^{2} & [ 12 ] \\ D1 ( y , {i}_{0} , {j}_{0} , p ) = {\sum }_{i = {i}_{0} + 1}^{{i}_{0} + p} yi , {j}_{0} & [ 13 ] \\ D2 ( y , {i}_{0} , {j}_{0} , p ) = {\sum }_{i = {i}_{0} + 1}^{{i}_{0} + p} yi , {j}_{0}^{2} \\ and & [ 14 ] \\ D3 ( x , y , {i}_{0} , {j}_{0} , p ) = {\sum }_{i = {i}_{0} + 1}^{{i}_{0} + p} xi , {j}_{0} * yi , {j}_{0} & [ 15 ]\end{matrix}$$

and their extension variables:

$$\begin{matrix}G1 ( x , {i}_{0} , {j}_{0} , p , q ) = {\sum }_{j = {j}_{0} + 1}^{{j}_{0} + q} D1 ( x , {i}_{0} , j , p ) & [ 16 ] \\ G1 ( y , {i}_{0} , {j}_{0} , p , q ) = {\sum }_{j = {j}_{0} + 1}^{{j}_{0} + q} D1 ( y , {i}_{0} , j , p ) & [ 17 ] \\ G2 ( x , {i}_{0} , {j}_{0} , p , q ) = {\sum }_{j = {j}_{0} + 1}^{{j}_{0} + q} D2 ( x , {i}_{0} , j , p ) \\ and & [ 18 ] \\ G3 ( x , y , {i}_{0} , {j}_{0} , p , q ) = {\sum }_{j = {j}_{0} + 1}^{{j}_{0} + q} D3 ( x , y , {i}_{0} , j , p ) & [ 19 ]\end{matrix}$$

All D's vanish if p<1 and all G's vanish if q<1.

Substituting the above definitions into equations [5]-[7], for a gate starting at a starting position (i,j) and having n lines of m pixels each, there is obtained:

var(x,i,j,n,m)=[G2(x,i,j,n,m)−G1(x,i,j,n,m)/(n*m)]/(n *m) [20]

var(y,i,j,n,m)=[G2(y,i,j,n,m)−G1²(y,i,j,n,m)/(n*m)]/(n*m) [21]

cov(x,y,i,j,n,m)=G3(x,y,i,j,n,m)/(n*m)−{G1(x,i,j,n,m)/(n*m)}* {G1(y,i,j,n,m)/(n*m)} [22]

The same calculations can be done using the template's modified pixel values, defined in equation [8]. The average, or mean, pixel value for a template is defined as:

y=G1(y,i₀,j₀,p,q)/(p*q) [23]

Thus, the sums D1(y,i₀·j₀·p) and G1(y,i₀,j₀,p,q) have to be calculated. However, G1′(y′,i₀,j₀,p,q) vanishes! The template's variance can be calculated in either of two ways, with no difference in computation effort. One way is as defined in equation [21] above, and the other, using the modified pixel values:

var(y,i,j,n,m)=G2′(y′,i,j,n,m)/(n*m) [24]

where G2′ and D2′ have the same formular definitions as G2 of equation [18] and D2 of equation [14], with y′ replacing y.

The covariance is calculated here according to equation [9], yielding:

cov(x,y,i,j,n,m)=G3′(x,y′,i,j,n,m)/(n*m) [25]

where G3′ is defined as

$$\begin{matrix}{G3}^{′} ( x , {y}^{′} , {i}_{0} , {j}_{0} , p , q ) = {\sum }_{j = {j}_{0} + 1}^{{j}_{0} + q} {D3}^{′} ( x , {y}^{′} , {i}_{0} , j , p ) \\ and & [ 26 ] \\ {D3}^{′} ( x , {y}^{′} , {i}_{0} , {j}_{0} , p ) = {\sum }_{i = {i}_{0} + 1}^{{j}_{0} + p} {x}_{ij0} * {y}_{ij0}^{′} & [ 27 ]\end{matrix}$$

This definition of the covariance is simpler and much faster to calculate than that of equation [22].

When an additional template and gate are employed and positioned at starting point (i+i1,j+j1), having n1 lines of m1 pixels each, the inclusion in the main template limits the position and dimension by:

1≦i1≦(n−n1+1); 1≦j1≦(m−m1+1) [28]

The main gate's variables can now be written as:

D1(x,i,j,n)=D1(x,i,j,i1−1)+D1(x,[i+i1−1],j,n1)+D1(x,[i+i1+n1−1],j[n+1−n1−i1]) [29]

where the middle term on the right hand side of equation [29] is the term D1(x,k,j,n1) used in the correlation equations for the additional template.

In the above embodiment, where n1 is an integer divisor g of n (n=g*n1), D1(x,i,j,n1) can be calculated once for each point (i,j) in the search area. The same can be done for D1(y,i,j,n1), D2(x,i,j,n1) and D2(y,i,j,n1). Each of these sums appears in the calculation of the correlation for many points, and thus a significant reduction in computation effort is achieved.

Correlations can be calculated for additional templates with line dimension n1 at any desired point without recalculating the D sums. The main template can also be calculated at any point, using the relation

$$D1 ( x , i , j , n ) = {\sum }_{k = 0}^{g - 1} D1 ( x , i + k * n1 , j , n1 ) \qquad [ 30 ]$$

and similar equations for D1(y,i,j,n), D2(x,i,j,n) and D2(y,i,j,n). This calculation re-uses the calculated D1 sums, and thus requires a minor additional computational effort. The main template sums can also be calculated once for each point (i,j) in the search area, and be used for calculating correlations at many points (up to n*m points for the main gate alone), with an additional saving of computation effort.

In the above embodiment, where m1 is an integer divisor h of m (m=h*m1), G1(x,i,j,n1,m1) can be calculated once for each point (i,j) in the search area. The same can be done for G1(y,i,j,nl,m1), G2(x,i,j,n1,m1) and G2(y,i,j,n1,m1). Each of these sums appears in the calculation of the correlation for many points, and thus a significant reduction in computation effort is achieved.

Correlations can be calculated for additional templates with column dimension m1 at any desired point without recalculating the G sums. The main template can also be calculated at any point using the relation

$$G1 ( x , i , j , n , m ) = {\sum }_{t = 0}^{h - 1} G1 ( x , i , j + t * m1 , n , m1 ) \qquad [ 31 ]$$

where G1(x,i,j+k*m1,n,m1) is defined as

$$G1 ( x , i , j + t * m1 , n , m1 ) = {\sum }_{k = 0}^{g - 1} G1 ( x , i + k * n1 , j , + t * m1 , n1 , m1 ) \qquad [ 32 ]$$

and similar equations for G1(y,i,j,n,m), G2(x,i,j,n,m) and G2(y,i,j,n,m). This calculation re-uses the calculated G1 sums, and thus requires a minor additional computational effort. These main template sums can also be calculated once for each point (i,j) in the search area, and be used for calculating correlations at many points, with an additional saving of computation effort.

Using the above equations [11] to [22] and [30] to [32], each point in the extended search area is used only once, while permitting the correlations of both the main and the additional templates to be calculated at any desired position in the search area. The extended search area is the search area plus a margin of m-1 pixels beyond the last pixel of the search area and a margin of n-1 lines beyond the last line of the search area. Ion comparison and non-optimized methods use each point n*m times.

A further improvement in computation time can be achieved by searching, not for the maximum of the correlation itself, but for the maximum of

IT(x, y)=cov (x,y)²/var(x) [33]

This improvement is based on the fact that where the correlation has a maximum, so does its square, while calculating the square root is much more time-consuming than multiplication.

Also, since the search is done for correlation against a given template, the division by the template's variance is a division by a constant, which does not affect the position of the maximum.

The same can be said about normalization by the size of the template (n*m or p*q), yielding an optimized search for the maximum of

G4(x,y,i,j,n,m)=G3′(x,y,i,j,n,m)²/[G2(x,i,j,n,m)* (n*m)−G1(x,i,j,n,m)²] [34]

If necessary, normalization of the resulting values to the true correlation values can be performed in a neighborhood around the position of the maximal correlation. Such a normalization may be necessary for comparing the correlation values in different templates.

The maxima found by the search are usually in integer pixel locations. As is customary in other systems, the correlation values around the maximum may be used to find the position of the correlation peak with sub-pixel accuracy, using methods such as fitting the correlation data to a 2-dimensional paraboloid and calculating the position of said paraboloid's maximum. However, in the method of the present invention, if this refinement and sub-pixel positioning is performed, it is done for each gate separately.

The positions of the correlation maxima or peaks in the different gates are used, together with the values of said maxima or peaks, to decide what type of change is occuring in the appearance of the object: This is done by computing the relative shift vectors and analyzing their differences as described above. The decision regarding the type of change affects the action the system takes, such as updating the templates more frequently or even immediately; refraining from updating the templates; using all of the maximaum template positions to create a representative current object position, or refraining from using some (or even all) of the maximum template positions for that purpose.

The shift vectors in the different templates are also used to calculate a representative shift vector, showing the motion of the object blob in the image. In some cases, the representative shift vector is the weighted average of the shift vectors derived from the correlation peak at each template, where the weights depend on the values of the respective correlation peaks, increasing with increasing peak values. Other embodiments may use different methods such as, for example, setting the representative shift vector to be the median of the separate vectors, or to be the vector with the highest respective correlation peak value.

In a still further embodiment of the invention, the method is applied to object tracking, where the main template includes essentially the entire blob of the tracked object. In this embodiment, additional templates are used, whose dimensions are integer divisors of the main template, and are essentially inside the main template. In the embodiment of FIG. 11, the main template K, is completely covered by the additional templates K₂ to K₁₇. Such templates make full use of the benefits of the invention.

FIG. 12 illustrates the method of the invention as applied to object tracking, where the main template K₁ includes essentially the entire blob of the tracked object. In this embodiment, additional templates K₂ to K₁₀ are used, whose dimensions are integer divisors of the main template, and which are essentially inside the main template. The main template K₁ is completely covered by the additional templates K₂ to K₁₀, with no overlap between the additional templates. Such templates make full use of the benefits of the invention, with minimal computational effort.

The method according to the invention can be applied to object tracking, where the template data is prepared at, or shortly after, the time of template acquisition and before using the templates for searching the object. The preparation comprises calculating and storing the mean and variance of the pixel values for the main template and for the additional templates.

Alternatively, the method is applied to object tracking, where the template data is prepared at, or shortly after, the time of template acquisition and before using the templates for searching the object, and the preparation comprises, in addition, subtracting the mean value of each template's pixel values from all of the template's pixel values and storing the results as each template's modified pixel values.

Still alternatively, the method is applied to object tracking, where the search area data is prepared at, or shortly after, the time of the acquisition of the current image and before starting the search for the object, and the preparation comprises calculating the sums, the means, the sums of squares and the variances of the pixel values for the main gate and the additional gates, where the set of gates is positioned at all search positions.

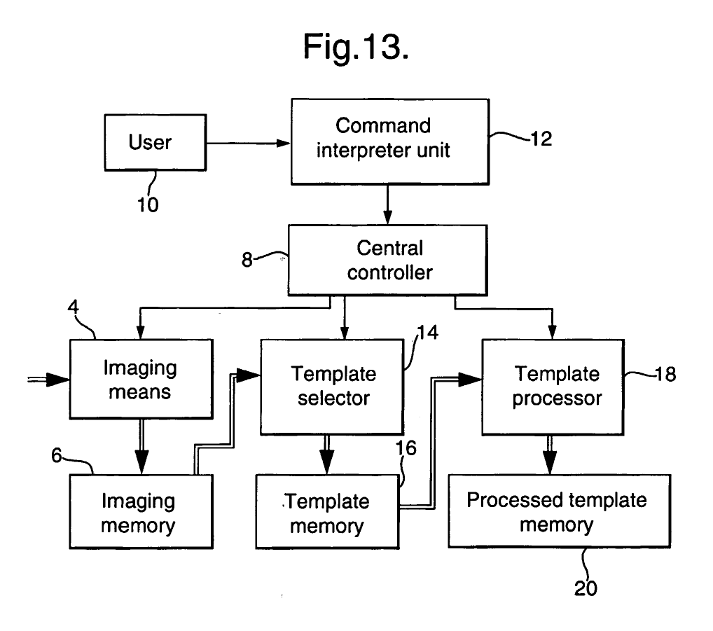

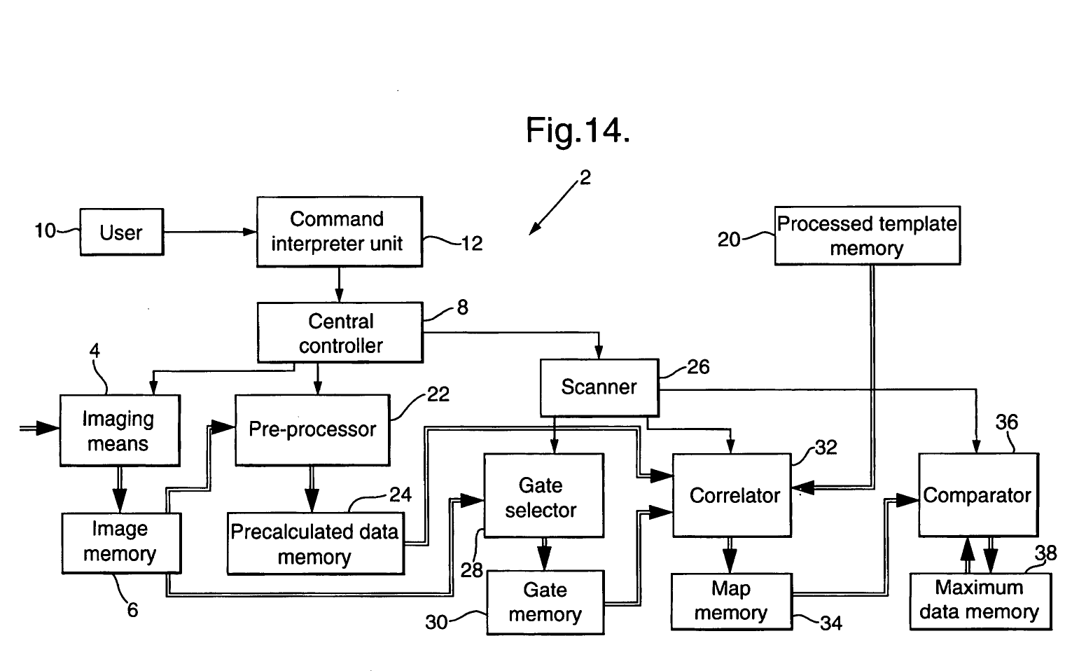

The system for following an object's characteristics using correlation in multiple templates is illustrated in FIGS. 13 and 14. The thin lines and arrows denote command flow, while the double-lined arrows denote data flow.

The imaging means 4 is any imaging means that loads image data (as given by pixel values) into a computer image memory 6 and includes, as necessary, detectors, amplifiers, image intensifiers, image correctors of any sort, frame grabbers and any other component preceding the storage of the image in memory 6. In addition, units such as, for example, adders, multipliers, gate arrays and digital signal processors, which operate as parts of one sub-system at one time, may operate as parts of another sub-system at other times.

The operation of the multi-template correlation system is controlled by central controller 8, which may or may not be part of a central processing unit. All other processors mentioned below may be parts of other processors, such as a central processing unit, which may be implemented in software or in hardware. Also, the memories mentioned below may be RAM memories of different subtypes, sequential memories of different types or fast magnetic media memories, and may be part of larger memory units.

FIG. 13 illustrates the functions during the stage involving the selection of templates. Upon receiving an input from the user 10 through user command interpreter unit 12, the reference image is stored in image memory 6 and applied to template selector 14, storing the image data within the selected templates in template memory 16. The templates are then processed by template processor 18 and the processed templates data is stored in processed template memory 20. The template processor 18 calculates the average, variance and modified pixel values as necessary for each template.

FIG. 14 illustrates the operation of the system 2 during the stage involving the following of the characteristics of the object. A current image, as viewed by the imaging means 4, is stored in the image memory 6. A pre-processor means 22 calculates those variables such as the D sums and the G sums of equations [11] to [32], depending only on the starting position in the current image, and stores them in precalculated data memory 24. Scanner 26 scans the search area by steps, selecting different starting positions at each step. At each step, gate selector 28 is applied to the image for selecting the gates appropriate for the step's starting position. The image data within the selected gates is stored in gate memory 30.

At each step, correlator means 32 compares the modified template data which was stored in the processed template memory 20 to the image data in the gate memory 30 according to the above described method, using other data, stored in processed template memory 20 and in precalculated data memory 24. The correlation values are stored in map memory 34, in an arrangement following the arrangement of the starting points in the current image.

At each step, the calculated correlations are compared in comparator 36 with the maximum data values previously stored in maximum data storage 38. If any correlation is larger than its respective maximum value, then the maximum data is replaced. The maximum data comprises, for each gate, the maximal correlation value and the line and column of the starting position where it was found. Each gate/template pair has a set of maximum data appropriate to it.

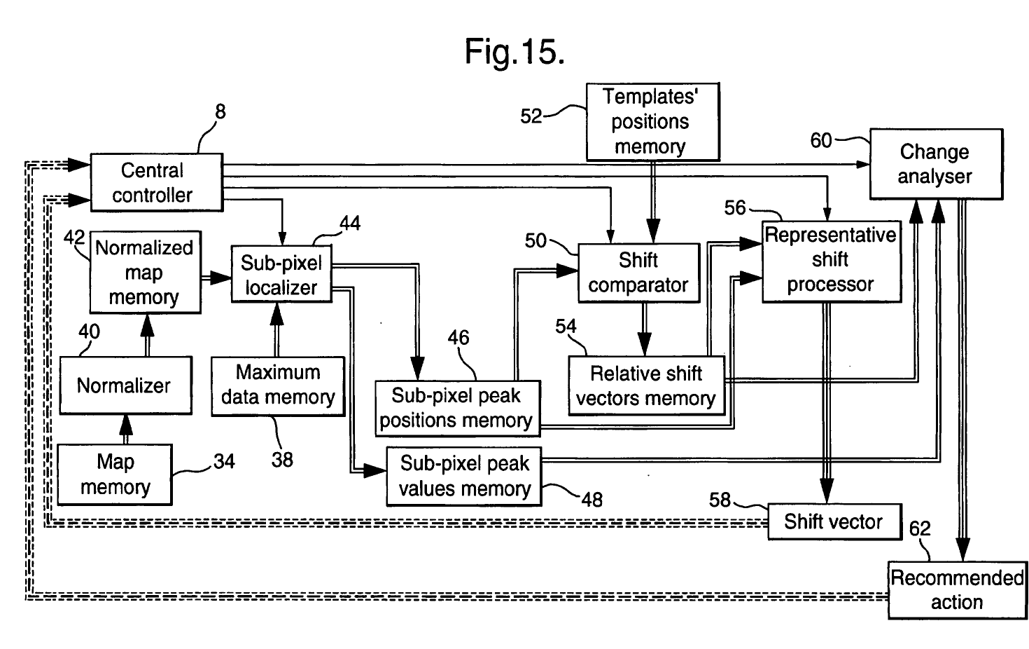

The core of the present invention is using the plurality of template/gate pairs, as will now be described with reference to FIG. 15. For optimal results, it is required that the correlation values from the different pairs be on the same scale. Thus, at the end of the scan, normalizer 40 normalizes the correlation values stored in the map memory 34 and stores them in normalized map memory 42. The normalized memory maps are processed in sub-pixel localizer 44 to find the sub-pixel peak positions and values, based on the maximum data stored in maximum data memory 38. The sub-pixel peak positions of the gates are stored in sub-pixel peak position memory 46 and the corresponding sub-pixel peak values are stored in sub-pixel peak value memory 48. Shift comparator 50 compares the shifts between the template positions, as stored in template position memory 52 and the shifts between the gate positions, as stored in sub-pixel peak position memory 46, and the results are stored in relative shift vector memory 54. Representative shift processor 56 calculates a shift vector 58, using the various relative shift vectors stored in relative shift vector memory 54 and the sub-pixel peak positions as stored in sub-pixel peak position memory 46.

The shift vector 58 is the output of the system 2, to be used by other means as necessary (e.g., in a tracker means, to control changing the line of sight of the imaging means so as to follow the object). As illustrated by the thick hatched lines, the shift vector can also be fed back into the central controller 8, where further processing may be performed on it, the results of which may affect the results of the system when operating on succeeding images.

Change analyzer 60 analyzes the various relative shift vectors stored in relative shift vector memory 54, together with their respective sub-pixel peak values as stored in sub-pixel peak value memory 48. It determines the type of change occurring in the image. An additional output of the system 2 is a recommended action 62. For example, in a tracking system, the recommended action may cause a temporary halt in the use of the results of the correlative tracker, relying for a time on other means. The recommended action 62 is also fed back (see the thick hatched lines) into the central processor for further processing as necessary.

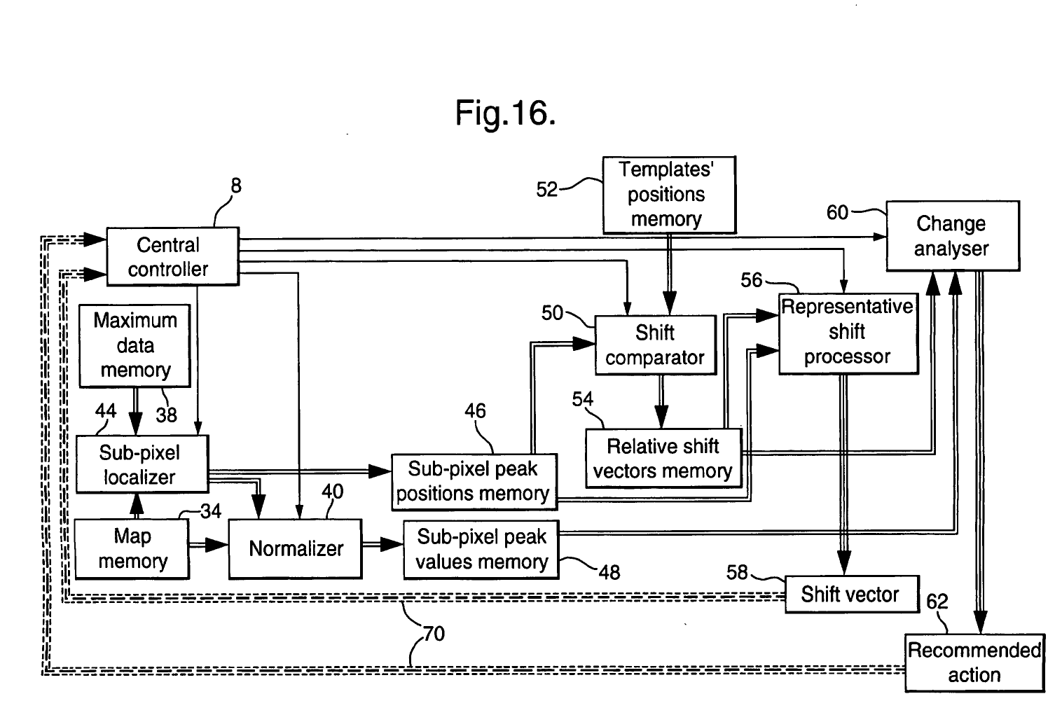

An alternative arrangement, illustrated in FIG. 16, shows the sub-pixel localizer 44 preceding the normalizer 40. Otherwise, the system is the same as that of FIG. 15.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A method for tracking characteristics of an object, said method comprising:
acquiring image data of a first image of the object to be tracked, as viewed by an imaging unit;
storing data representing a selected portion of said first image, thus forming a first template having first defined dimensions;
storing data representing at least one different portion of said first image, thus forming a second template having second template dimensions;
acquiring image data of a second image of said object to be tracked, as viewed by said imaging unit;
defining a search area comprising portions of said second image;
defining a first gate in said search area, said gate possessing dimensions identical to those of said first template, thus forming a first template/gate pair;
defining at least one second gate in said search area, said at least one second gate possessing dimensions identical to those of said second template, thus forming at least one second template/gate pair;
said template/gate pairs being stored in the form of pixel values;
calculating correlations between the data of said template/gate pairs at different locations in said search area;
determining the locations of each template/gate pair where said correlations are the highest, and
noting said determined locations.

2. The method according to claim 1, further comprising the step of:
determining the shift between the position of at least one template/gate pair relative to a selected, other template/gate pair.

3. The method according to claim 1, further comprising the steps of:
determining the positions of maximal correlation for different template/gate pairs, and
computing the relative shift vectors of the template/gate pairs and analyzing their differences,
whereby changes in the appearance of the tracked object can be determined.

4. The method according to claim 1, wherein a plurality of template/gate pairs is provided, a first one of said pairs essentially including an image of the entire object to be tracked; the dimensions of further template/gate pairs being integer divisors of, and located inside, said first template/gate pair, with or without overlap.

5. The method according to claim 1, comprising calculating and storing the mean and variance pixel values of each of said templates.

6. The method according to claim 1, wherein templates are prepared by calculating the mean pixel value of one of said templates and subtracting it from each pixel value in said template.

7. The method according to claim 1, wherein partial sums of said pixel values are calculated over the entire search area and stored, to be eventually used for calculating correlations of the plurality of template/gate pairs.

8. The method according to claim 1, further comprising the step of normalizing correlation values from different template/gate pairs.

9. The method according to claim 1, further comprising the step of combining noted locations and correlation values to calculate and obtain a new location.

10. The method according to claim 9, wherein said combining comprises calculating the weighted average of said noted locations.

11. The method according to claim 3, wherein said changes in the appearance of the tracked objects are determined by changes in the distance of the tracked object from said imaging unit.

12. The method according to claim 3, wherein said changes in the appearance of the tracked objects are determined by changes in the orientation of the tracked object relative to said imaging unit.

13. The method according to claim 3, wherein said changes in the appearance of the tracked objects are determined by the obscuration of portions of said object from being viewed by said imaging unit.

14. The method according to claim 3, further comprising the step of analyzing changes in the appearance of said tracked object.

15. The method according to claim 14, wherein said templates are updated periodically, the length of time between said updates being determined by the results of said analysis.

16. The method according to claim 1, further comprising the step of shifting the line of sight of said imaging unit to follow determined or predicted changes in said determined location.

17. The method according to claim 1, further comprising the steps of:
calculating shift vectors between the location of each template and said first template;
calculating shift vectors between the determined locations of each gate and the determined location of said first gate;
calculating relative shift vectors for each template/gate pair;
comparing the relative shift vectors of said template/gate pairs;
comparing correlation values of different template/gate pairs, and
analyzing the temporal behavior of said correlation values and said relative shift vectors;
whereby changes in the appearance of said tracked object can be determined.

18. A system for tracking characteristics of an object, said system being connectable to an imaging unit, comprising:
means for acquiring template data;
a first memory for storing data representing at least two templates;
means for acquiring image data;
a second memory for storing at least two gate data selected from an area of the image to be searched;
means for selecting gate positions in the search area;
a third memory for storing template locations;
a fourth memory for storing gate locations;
a correlator receiving data from said first and second memories for comparing template data stored in said first memory to the gate data stored in said second memory and storing correlation values of template/gate pairs in a map memory;
a maximum data memory storing a maximal correlation value for each template/gate pair, constantly replacing any previous correlation value which is lower than said maximal correlation value;
means for calculating a shift vector between a template location and a gate location, and
a central controller and processing unit.

19. The system as claimed in claim 18, further comprising an analyzer for analyzing changes of appearance of the tracked object.

20. The system as claimed in claim 18, further comprising a normalizer for receiving signals from said map memory for processing correlation values from different template/gate pairs, to produce values on the same scale.

21. The system as claimed in claim 18, further comprising a sub-pixel localizer for receiving signals from said map memory for finding sub-pixel peak positions and values, based on maximum data stored in said maximum data memory.

22. The system as claimed in claim 20, further comprising a sub-pixel localizer for receiving signals from said map memory via said normalizer for finding sub-pixel peak positions and values, based on maximum data stored in said maximum data memory.

23. The system as claimed in claim 18, wherein said means for forming relative shift vectors comprises a shift comparator for receiving signals from a template position memory, a relative shift vector memory fed by said shift comparator, and an analyzer for analyzing changes of appearance of the tracked object.

24. The system as claimed in claim 18, further comprising:
means for changing the line of sight of said imaging unit, and
means for transmitting a shift vector to said means for changing the line of sight.
